(19) United States
(12) Patent Application Publication
(10) Pub. No.: US 2017/0129469 A1
(43) Pub. Date: May 11, 2017

(54) ARRANGEMENT FOR A HYDRAULIC MOTOR VEHICLE BRAKE SYSTEM, AND BRAKE SYSTEM HAVING AN ARRANGEMENT OF SAID TYPE

(71) Applicant: Continental Teves AG & Co. oHG, Frankfurt (DE)

(72) Inventors: Marco Besier, Bad Schwalbach (DE); Stefan Drumm, Saulheim (DE); Johann Jungbecker, Badenheim (DE); Paul Linhoff, Neu-Anspach (DE)

(73) Assignee: Continental Teves AG & Co. oHG, Frankfurt (DE)

(21) Appl. No.: 15/409,902

(22) Filed: Jan. 19, 2017

Related U.S. Application Data
(63) Continuation of application No. PCT/EP2015/066231, filed on Jul. 16, 2015.

(51) Int. Cl. B60T 13/14; B60T 13/68; B60T 13/66

(52) U.S. Cl. CPC B60T 13/142; B60T 13/662; B60T 13/686

(57) ABSTRACT

A hydraulic motor vehicle brake system arrangement includes an inlet pressure port, a tank port, an outlet pressure port, a normally open valve which can be controlled in an analog fashion and is arranged between the inlet pressure port and the outlet pressure port, and a pump with a suction side and a pressure side. The suction side of the pump is connectable to the inlet pressure port and to the tank port. A first check valve, which opens in the direction of the suction side, is arranged in the connection between the suction side and the tank port.

### CROSS REFERENCE TO RELATED APPLICATION

This application claims the benefit of International application No. PCT/EP2015/066231, filed Jul. 16, 2015, which is hereby incorporated by reference.

### TECHNICAL FIELD

The technical field relates generally to a brake system for a motor vehicle.

### BACKGROUND

International patent application WO 2012/150120 A1 discloses a hydraulic motor vehicle brake system with a tandem brake master cylinder which can be actuated by a brake pedal, with an electrically controllable pressure modulation device for setting brake pressures at individual wheels, and with an electronically controllable pressurization device (pump-valve module) with four pumps driven by an electric motor. Two of the pumps are connected on the suction side to a pressure medium storage tank, and the other two pumps are connected on the suction side to the tandem brake master cylinder. Depending on operating state, it is necessary to draw a pressure medium volume either from the tandem brake master cylinder or from the pressure medium storage tank. In order to control the volume flows, in the pump-valve module of the previously known motor vehicle brake system, two pumps and two analog solenoid valves are required for each brake circuit. These must be controlled in a comparatively complex fashion, by means of a closed electronic control loop based on pressure sensor signals. Also, it is disadvantageous that two pumps and two analog solenoid valves are provided for each brake circuit. A further disadvantage is that in operation, the pumps connected to the pressure medium storage tank must constantly deliver against the system pressure. Hydraulically, in the previously known brake system, it is not possible to switch the pumps connected to the pressure medium storage tank into a state of pressureless circulation.

It is therefore desirable to provide a more economic arrangement, with simpler structure, for a hydraulic motor vehicle brake system, and a brake system having such an arrangement, which eliminate said disadvantages. In addition, other desirable features and characteristics will become apparent from the subsequent summary and detailed description, and the appended claims, taken in conjunction with the accompanying drawings and this background.

### SUMMARY

In one exemplary embodiment, a hydraulic motor vehicle brake system arrangement includes an inlet pressure port, a tank port, an outlet pressure port, a normally open valve which can be controlled in an analog fashion and is arranged between the inlet pressure port and the outlet pressure port, and a pump with a suction side and a pressure side. The suction side of the pump is connectable to the inlet pressure port and to the tank port. A first check valve, which opens in the direction of the suction side, is arranged in the connection between the suction side and the tank port.

One advantage of such an arrangement is that only one pump is required per brake circuit of the brake system. Control of the suction volume flow is therefore straightforward. The composition of the pump suction volume flow from a portion from the inlet pressure port and a portion from the tank port is adjusted automatically, without the need for an electronic control unit to actuate analog valves. Therefore no additional analog solenoid valves are required for this. With little hydraulic complexity, using a check valve, it is achieved that the pressure medium volume is automatically drawn from the tank port only when the inlet pressure port delivers too small a volume flow in relation to the pump volume flow.

The volume output side of the first check valve may be connected to the hydraulic connection between the suction side and the inlet pressure port. This means that the volume output side of the check valve is connected to the suction side and to the inlet pressure port. The suction side is thus connected to a connecting segment which may be supplied with pressure medium from the inlet pressure port and the tank port.

In order to keep the suction resistance for the pump as low as possible, in some embodiments, no valve is arranged in the hydraulic connection between the suction side and the inlet pressure port.

According to another exemplary embodiment of the arrangement, a normally closed second valve is arranged in the hydraulic connection between the suction side and the inlet pressure port. In this way, a pressure medium flow from the inlet pressure port to the suction side can be shut off or released as required. By means of the second valve, it is possible that pressure medium is drawn in by the pump exclusively via the tank port. However, only the second valve, i.e., no further valve, is arranged in the hydraulic connection.

According to a further exemplary embodiment of the invention, a hydraulic connection is provided between the outlet pressure port and the tank port, in which a normally closed third valve is arranged. A normally closed third valve is connected in parallel to the pump and the first check valve. By means of the third valve, it is possible to dissipate a pressure at the outlet pressure port (e.g., at the wheel brakes) directly to the tank port (e.g., to the pressure medium storage tank).

A further hydraulic connection may be provided between the outlet pressure port and the tank port, in which a second check valve is arranged. The second check valve opens in the direction of the outlet pressure port and is connected in parallel to the pump and the first check valve. The pump with the first check valve, the third valve, and the second check valve are each connected in parallel with each other. The further hydraulic connection to the second check valve allows a flow of pressure medium from the tank port to the pressure outlet port with little hydraulic resistance. This is particularly advantageous in a brake system in which the arrangement (a pump-valve module) is arranged between a brake master cylinder and a second pressurization device (in particular a second pump-valve module).

According to an exemplary embodiment of the arrangement, this arrangement is configured in multiple circuits, i.e., at least two circuits. For each circuit, the arrangement comprises an inlet pressure port, an outlet pressure port, a pump with suction side which is or can be connected to the inlet pressure port, and a pressure side which is or can be connected to the outlet pressure port, and a normally open first valve which can be controlled in analog fashion and is arranged between the inlet pressure port and the outlet pressure port. Thus each circuit of the arrangement may be assigned to a brake circuit of a brake system which is e.g., normally a dual circuit system. Each circuit of the arrangement may also be assigned to a wheel brake circuit of a brake system.

The pumps may be driven jointly by an electric motor.

According to an exemplary embodiment of the arrangement, this comprises only the one tank port, wherein the suction sides of the pumps are connected to the tank port. Having only one tank port (for all circuits) reduces the complexity of the hydraulic assembly of the arrangement in a brake system.

With only one tank port, the arrangement comprises, for each circuit, a first check valve arranged between the suction side of the pump and the tank port.

Alternatively, two or more suction sides are jointly connected to the tank port via a first check valve. This reduces the number of first check valves and hence also the costs.

According to another exemplary embodiment of the arrangement, each circuit includes a separate tank port, and for each circuit a first check valve is arranged between the suction side of the pump and the tank port. This embodiment is advantageous for a fully dual- or multi-circuit brake system. The tank ports of the arrangement are then each connected to the (respective) chamber of the pressure medium storage tank assigned to the corresponding brake circuit of the brake system.

Another exemplary embodiment of the arrangement includes at least two tank ports wherein at least one—in particular each—of the tank ports is connected to the suction sides of at least two pumps. Advantageously, for each suction side, a first check valve is provided which is arranged between the suction side of the pump and the assigned tank port, or for each tank port, a first check valve is provided which is arranged between the suction side of the pump and the tank port, i.e., two or more suction sides are jointly connected to the tank port via a first check valve.

In a multicircuit arrangement, for each circuit, no valve is arranged in the hydraulic connection between the suction side and the inlet pressure port.

In a multicircuit arrangement, for each circuit, a—in particular only one—normally closed second valve is arranged in the hydraulic connection between the suction side and the inlet pressure port.

In a multicircuit arrangement, for each circuit, a hydraulic connection is provided between the outlet pressure port and the assigned tank port, in which a normally closed third valve is arranged.

In a multicircuit arrangement, for each circuit, a further hydraulic connection is provided between the outlet pressure port and the assigned tank port, in which a second check valve is arranged which opens in the direction of the outlet pressure port.

The arrangement may include at least a first pressure detection device which detects the pressure at the inlet pressure port or one of the inlet pressure ports. The arrangement furthermore may include a second pressure detection device which detects the pressure at the outlet pressure port or one of the outlet pressure ports.

The hydraulic components of the arrangement may be configured as an autonomous assembly, i.e., a so-called pump-valve module. An electronic control and regulator unit may be assigned to the arrangement or the pump-valve module and may be arranged on the assembly.

A brake system with an arrangement described above may also be contemplated. In one exemplary embodiment, the brake system includes hydraulically actuatable wheel brakes, a brake master cylinder which can be actuated via a brake pedal and has pressure chambers, wherein at least one of the wheel brakes is assigned to each pressure chamber, a pressure medium storage tank assigned to the brake master cylinder and standing under atmospheric pressure, an electrically controllable pressure modulation device for setting brake pressures at individual wheels, with at least one inlet valve and advantageously one outlet valve for each wheel brake, and an electrically controllable pressurization device.

According to one exemplary embodiment of the brake system, a pump-valve module arrangement is hydraulically arranged between the brake master cylinder and the electrically controllable pressurization device.

The electrically controllable pressurization device may be configured as a second pump-valve module. The pressurization device may include a pump and valves, and advantageously a low-pressure accumulator.

The pressurization device and the pressure modulation device may be connected downstream thereof together from a pump-valve module known in itself (ESC module, Electronic Stability Control).

In one exemplary embodiment, each inlet pressure port of the arrangement is connected, particularly without the interposition of a valve, to the brake master cylinder, and each outlet pressure port of the arrangement is connected to the pressurization device.

In one exemplary embodiment, for each brake circuit (pressure chamber of the brake master cylinder), the arrangement includes a circuit. For each circuit of the arrangement, a hydraulic connection is provided between the outlet pressure port and the tank port, in which a second check valve is arranged and which opens in the direction of the outlet pressure port.

According to another exemplary embodiment of the brake system, an arrangement (or a pump-valve module) according to the invention is arranged hydraulically between the pressure modulation device and the wheel brakes.

The electrically controllable pressurization device may be connected upstream of the pressure modulation device.

Each inlet pressure port of the arrangement may connected—advantageously without the interposition of a valve—to the pressure modulation device, and each outlet pressure port of the arrangement is connected—advantageously without the interposition of a valve—to one of the wheel brakes.

Each inlet pressure port of the arrangement may be connected directly to one of the inlet valves of the pressure modulation device.

The pressurization device may be formed by a cylinder-piston arrangement, the piston of which may be actuated by an electromechanical actuator.

In order to be able to provide a high availability for the electrically controlled build-up of brake pressure, the brake system may include a first electronic control and regulator unit assigned to the pressurization device and the pressure modulation device, and a second electronic control and regulator unit assigned to the arrangement.

In a “brake-by-wire” operating mode, the brake system may be actuated both by the vehicle driver and independently of the vehicle driver.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic diagram of a pump-valve module arrangement of a hydraulic brake system according to a first exemplary embodiment;

FIG. 2 is a schematic diagram of a pump-valve module arrangement of a hydraulic brake system according to a second exemplary embodiment;

FIG. 3 is a schematic diagram of a pump-valve module arrangement of a hydraulic brake system according to a third exemplary embodiment;

FIG. 4 is a schematic diagram of a pump-valve module arrangement of a hydraulic brake system according to a fourth exemplary embodiment;

FIG. 5 is a schematic diagram of a pump-valve module arrangement of a hydraulic brake system according to a fifth exemplary embodiment;

FIG. 6 is a schematic diagram of a pump-valve module arrangement of a hydraulic brake system according to a sixth exemplary embodiment;

FIG. 7 is a schematic diagram of a hydraulic brake system according to a first exemplary embodiment;

FIG. 8 is a schematic diagram of a pump-valve module arrangement of a hydraulic brake system according to a seventh exemplary embodiment;

FIG. 9 is a schematic diagram of a hydraulic brake system according to a second exemplary embodiment.

### DETAILED DESCRIPTION

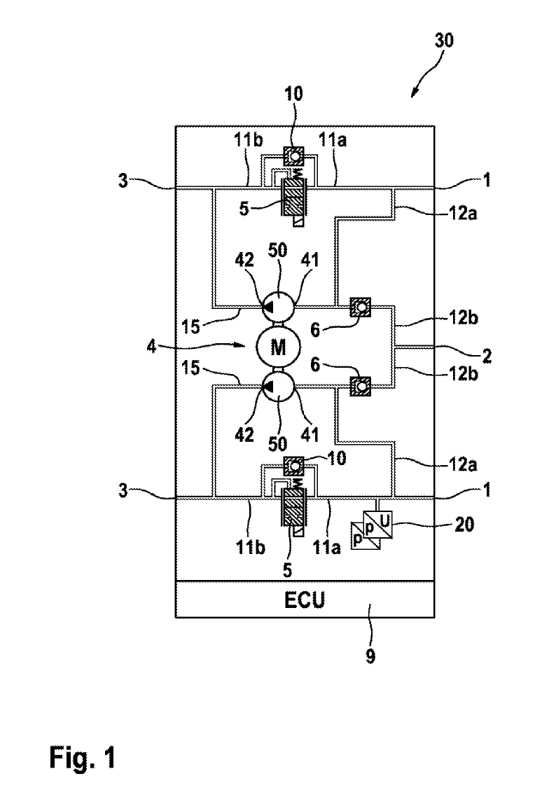

With reference to FIGS. 1-6 and 8, exemplary embodiments of arrangements (pump-valve modules) 30 are described, which may be utilized to supplement a main brake system which already includes an electrically controllable pressurization device (pressure generator).

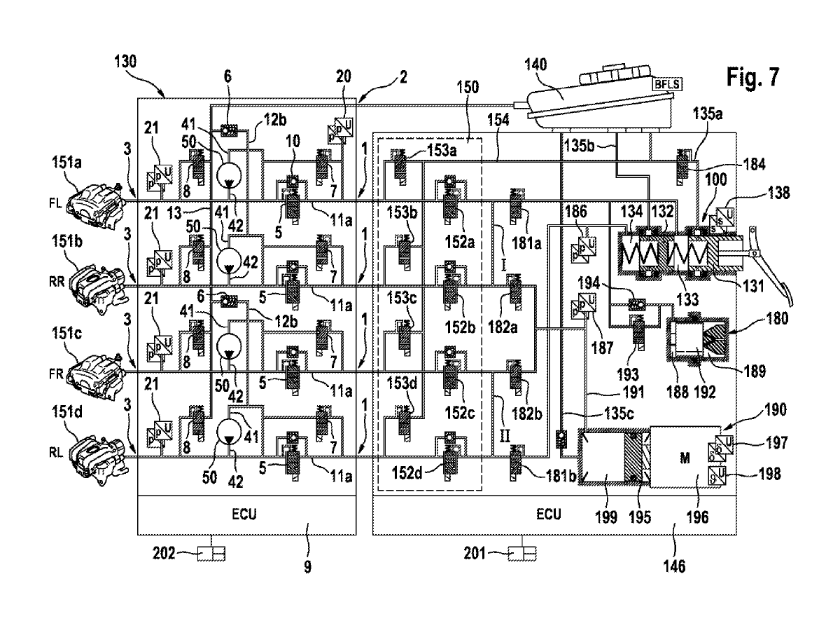

The exemplary arrangements (pump-valve modules) 30 are connected downstream of a main brake system. This offers the advantage that the pressure medium can be drawn directly from the tank. However, because of the flow resistances, intake through the main brake system could lead to insufficient volume flows. Particularly, the arrangement may be connected downstream of the inlet valves of the main brake system (see, e.g., FIG. 7).

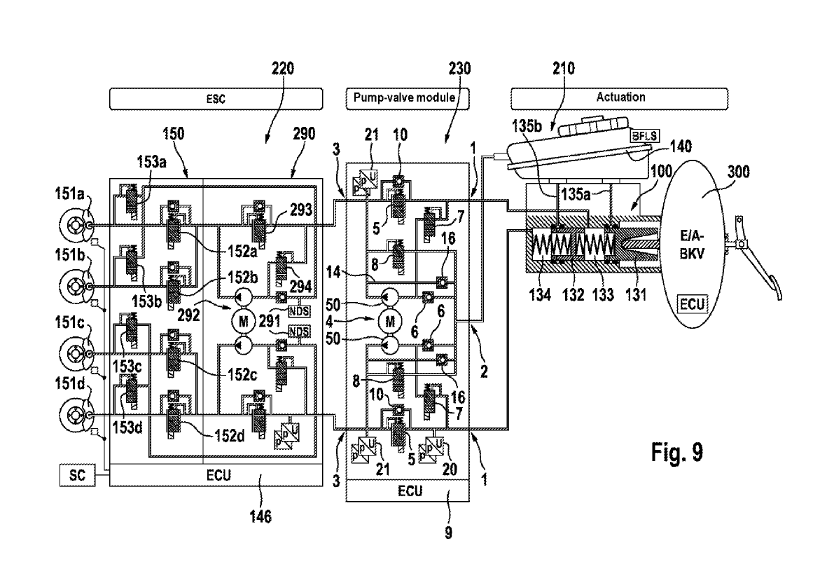

The exemplary arrangements (pump-valve modules) 30 may be arranged between the brake master cylinder and the inlet valves of the wheel brakes (see, e.g., FIG. 9).

For redundancy of the brake system, the exemplary arrangements 30 comprise a separate electronic control and regulator unit 9 and a pump arrangement 4, 40 (second electrically controllable pressure generator for the brake system), so that the complete brake system comprises two independent electronic control and regulator units and two independent pressure generators.

According to the example, the arrangements 30 comprise a hydraulic unit (HCU), an electronic unit 9 (ECU, electronic control and regulator unit), at least one pressure sensor 20, a motor M for driving pumps 50 and, for each circuit of the arrangement, a normally open analog valve 5.

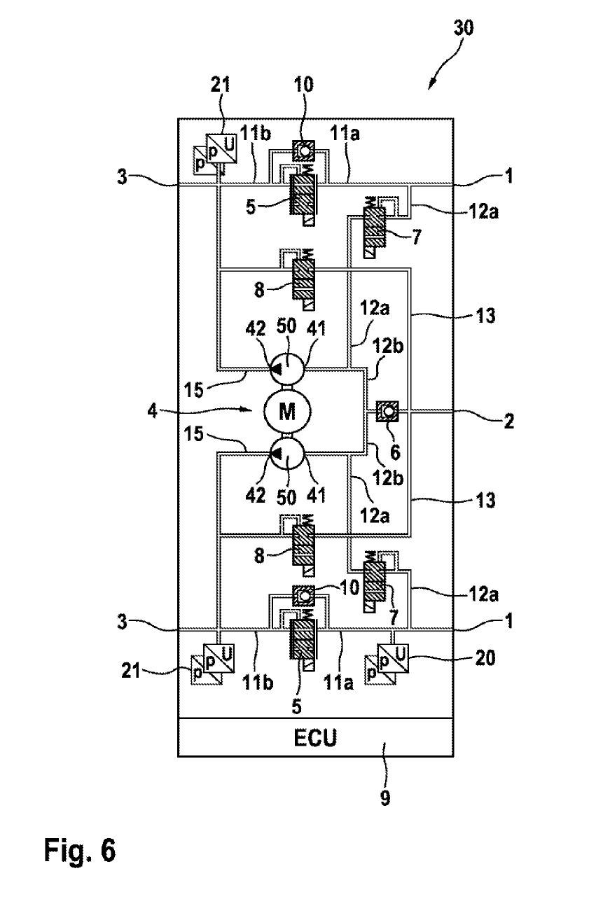

The exemplary arrangements 30 of FIGS. 1-5 and 8 include a check valve 6 for each circuit. The exemplary arrangement 30 of FIG. 6 includes a check valve 6 per tank port.

The check valves 6 may have a very low opening pressure and minimal residual leakage. Here, check valves 6 with a valve seat sealed with elastomer are particularly suitable. Valves of this type have already proved suitable as central valves in brake master cylinders.

FIG. 1 shows a first exemplary embodiment of the arrangement 30 for a hydraulic motor vehicle brake system. The arrangement 30 is configured with two circuits. In each circuit, the arrangement 30 includes a first port 1 (inlet pressure port, pressure input) e.g., for connection to a pressure source (not shown), a third port 3 (outlet pressure port, pressure output) e.g., for connection to a wheel brake (not shown), a pump 50 with a suction side 41 and a pressure side 42, and an electrically actuatable valve 5 arranged between the inlet pressure port 1 and the outlet pressure port 3. The arrangement 30 comprises a (single) second port 2 (tank port) for connection to a pressure medium tank or pressure medium storage tank (not shown). For this, the suction sides of the pumps are connected together via line portions 12b and connected jointly to the tank port 2.

The pressure source may be formed by a brake master cylinder. Advantageously, each pressure chamber of the brake master cylinder is or can be connected to one of the inlet pressure ports 1.

Further valves, e.g., pressure modulation valves, may be arranged between the brake master cylinder and the arrangement 30.

The pressure medium storage tank is advantageously a pressure medium storage tank under atmospheric pressure which, e.g., is assigned to the brake master cylinder.

The pressure medium storage tank may include a third chamber from which the pressure medium volume drawn in during operation is provided for the arrangement 30.

The exemplary dual-circuit arrangement 30 thus comprises a pump arrangement 4 with two pumps 50, i.e., a single pump 50 per circuit. The two pumps 50 of the pump arrangement 4 are driven jointly by an electric motor M. Each pump 50 comprises a suction side 41 and a pressure side 42. The description below concerns one of the circuits of the arrangement; the other circuit is constructed accordingly.

The (first) valve 5, which is configured normally open and can be controlled in analog fashion, is arranged in a hydraulic connection 11 between the inlet pressure port 1 and the outlet pressure port 3, with a line portion 11a (on the inlet pressure port side) and a line portion 11b (on the outlet pressure port side). A check valve 10 opening in the direction of the outlet pressure port 3 is connected in parallel to the valve 5.

The pressure side 42 of the pump 50 is connected via a line portion 15 to the associated line portion 11b and hence to the associated outlet pressure port 3.

The suction side 41 of the pump 50 is connected via a line portion 12a to the associated inlet pressure port 1. The suction side 41 is for example connected directly to the inlet pressure port 1, i.e., without the interposition of a valve.

In addition, the suction side 41 of the pump 50 is connected to the tank port 2 via a hydraulic connection (part of the line portion 12a and line portion 12b). A check valve 6, opening in the direction of the suction side 41 of the pump 50, is arranged in the hydraulic connection (between line portion 12a and 12b). The volume output side of the check valve 6 is connected to the hydraulic connection 12a between the suction side 41 and the inlet pressure port 1. Thus the volume output side of the check valve 6 is connected to the suction side 41 and the inlet pressure port 1. Therefore the suction side 41 of the pump 50 may be supplied with pressure medium from the inlet pressure port 1 and with pressure medium from the tank port 2. Other than the check valve 6, no further valve is arranged in the hydraulic connection between the suction side 41 and the second port 2.

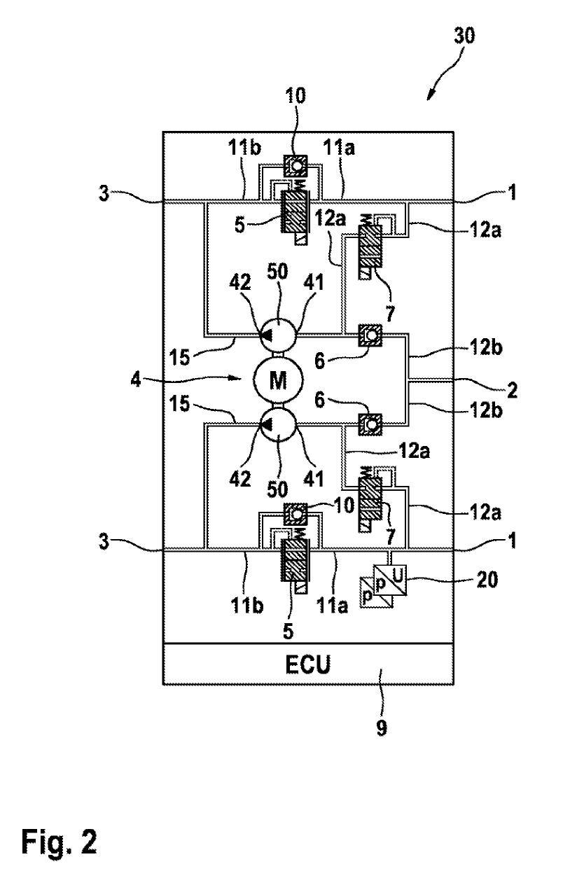

A second exemplary embodiment of the arrangement 30, shown in FIG. 2, corresponds to the first exemplary embodiment of FIG. 1, wherein additionally a normally closed second valve 7 arranged in the connection 12a is provided for each circuit. When not powered, the second valve 7 blocks the pressure medium volume flow from the inlet pressure port 1 to the pump suction side 41. When the second valve 7 is closed, the pump 50 is supplied via the tank port 2. When the second valve 7 is open, pressure medium volume may also be taken from the inlet pressure port 1. If the inlet pressure port 1 does not provide a sufficient volume flow, the pump 50 draws the additionally required pressure medium volume from the tank port 2.

According to the first and second exemplary embodiments, a single pressure sensor (pressure detection device) 20 is provided which detects the pressure at one of the inlet pressure ports 1.

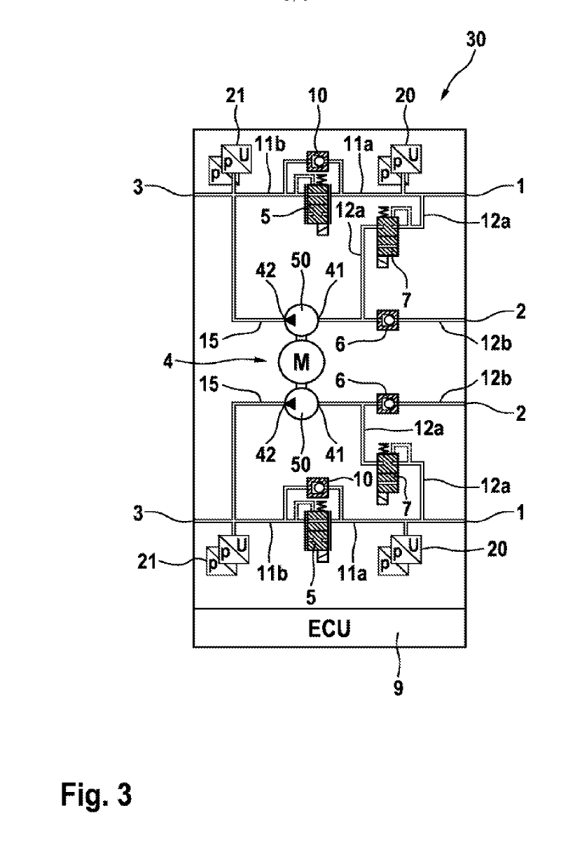

FIG. 3 shows a third exemplary embodiment of the arrangement 30, the hydraulic structure of which corresponds in principle to that of the second exemplary embodiment. However, for each circuit, this arrangement 30 includes an independent tank port 2, i.e., in total two tank ports 2. For each circuit, the arrangement 30 thus includes an inlet pressure port; a tank port 2; an outlet pressure port 3; a pump 50 with a suction side 41 which is connected to the inlet pressure port 1 via line portion 12a (with valve 7), and with a pressure side 42 which is connected to the outlet pressure port 3 via line portions 15 and 11b; an electrically actuatable valve 5 (with parallel-connected check valve 10) arranged in the hydraulic connection 11 between the inlet pressure port 1 and the outlet pressure port 3; and a check valve 6 which opens in the direction of the suction side 41 and is arranged in the connection 12a, 12b between the suction side 41 and the tank port 2.

This exemplary embodiment is advantageously used in fully dual-circuit brake systems. The tank ports 2 are connected to the respective tank chamber in the brake system according to the (brake) circuit division.

According to the third exemplary embodiment, each circuit comprises a pressure sensor 20 which detects the pressure at the respective inlet pressure port 1, and a pressure sensor 21 which detects the pressure at the respective outlet pressure port 3.

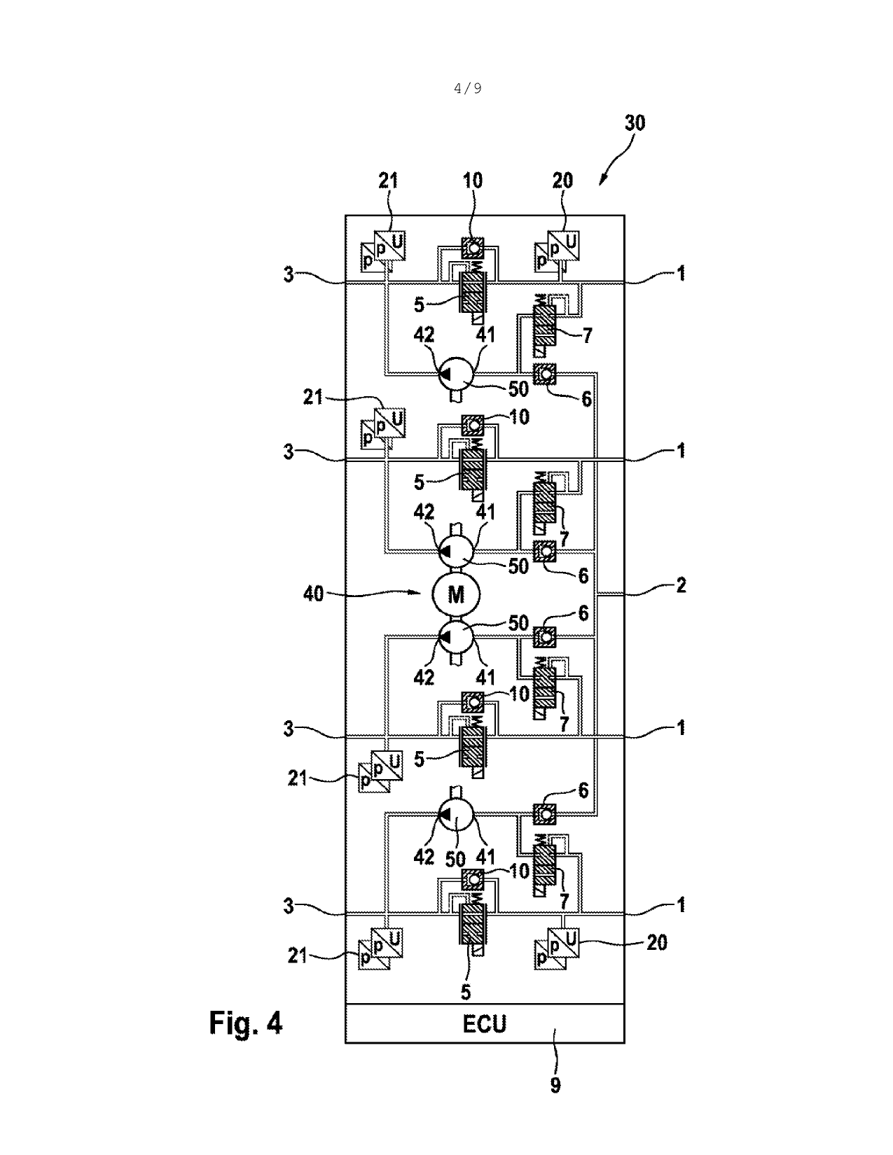

FIG. 4 shows a fourth exemplary embodiment of the arrangement 30. This arrangement 30 is configured with four circuits, each with an inlet pressure port 1, an outlet pressure port 3, a pump 50 with suction side 41 and pressure side 42, and a normally open valve 5 which can be controlled in analog fashion and is arranged between the inlet pressure port 1 and the outlet pressure port 3. In other words, the arrangement has four pressure inputs 1, four pressure outputs 3 and four pumps 50. The arrangement 30 has a common tank port 2 for the four circuits. Each circuit contains a check valve 6 between line portion 12a and 12b. The four line portions 12b are connected together and connected to the tank port 2. The basic hydraulic structure of a circuit otherwise corresponds to that of the second exemplary embodiment (FIG. 2).

A four-circuit arrangement may be constructed similarly to FIG. 1 without the valve 7 per circuit, or similarly to FIG. 2 (as shown in FIG. 4) with a valve 7 per circuit.

A four-circuit arrangement according to FIG. 3 with two tank ports 2, wherein each of the tank ports 2 is connected to the suction sides of two pumps, or with four tank ports 2, i.e., a separate tank port 2 per circuit, is also advantageous.

According to the fourth exemplary embodiment, for each circuit a pressure sensor 21 is provided which detects the pressure at the respective outlet pressure port 3. The pressure is detected by a pressure sensor 20 at two of the four inlet pressure ports 1.

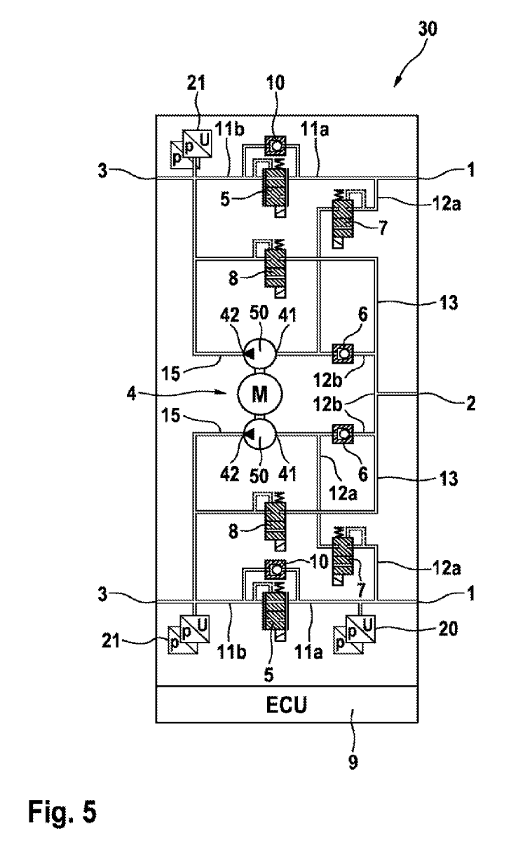

FIG. 5 shows a fifth exemplary embodiment of an arrangement according to the invention, the hydraulic structure of which corresponds in principle to that of the second exemplary embodiment. However, the arrangement additionally comprises, for each circuit, a hydraulic connection 13 between the tank port 2 and the outlet pressure port 3, in which a normally closed valve 8 is arranged. In other words, the valve 8 is connected in parallel to the pump 50 and the check valve 6. Pressure can be dissipated directly to the tank port 2 via the outlet valve 8. This is advantageous compared with pressure dissipation through the analog valve 5, via the inlet pressure port 1 and then through a (main) brake system connected upstream. When pressure is dissipated through the upstream brake system, sometimes substantial hydraulic resistances must be overcome, which can lead to a strong choke effect for the pressure dissipation volume flow. In ABS brake systems (anti-lock brakes), this could lead to problems if the pressure cannot be dissipated quickly enough. Therefore a valve 8 arranged in this fashion, which allows the pressure to be released directly to the tank via this one valve diaphragm only, is advantageous.

According to the fifth exemplary embodiment, for each circuit, a pressure sensor 21 is provided which detects the pressure at the respective outlet pressure port 3. The pressure is detected by means of a pressure sensor 20 at one of the inlet pressure ports 1.

An alternative arrangement of the check valve 6 will now be explained with reference to the sixth exemplary embodiment of FIG. 6. The sixth exemplary embodiment is based on the fundamental hydraulic structure of the fifth exemplary embodiment. A similar implementation in another hydraulic structure or exemplary embodiment is also possible. According to the exemplary arrangement, only a single check valve 6 is used, i.e., a single check valve 6 per tank port 2. For this, the suction sides 41 of the pumps 50 are connected together directly (without a check valve) via the line portions 12b, and the common line portion is connected to the tank port 2 via the check valve 6. In other words, the check valve 6 is connected downstream of the tank port 2, and only then is there a hydraulic branch to the pump suction inputs 41. According to the example, here again (for each circuit) the valve 8 is connected in parallel to the pump 50 and the check valve 6.

An arrangement corresponding to the exemplary embodiment shown in FIG. 5 (with valves 8) is also possible as a four-circuit arrangement with four inlet pressure ports 1, four outlet pressure ports 3 and four pumps 50 (similar to the exemplary embodiment shown in FIG. 4). An arrangement corresponding to the fifth exemplary embodiment is also possible with two tank ports 2, similar to FIG. 3. An arrangement corresponding to the fifth exemplary embodiment is also possible without the valves 7, similar to FIG. 1.

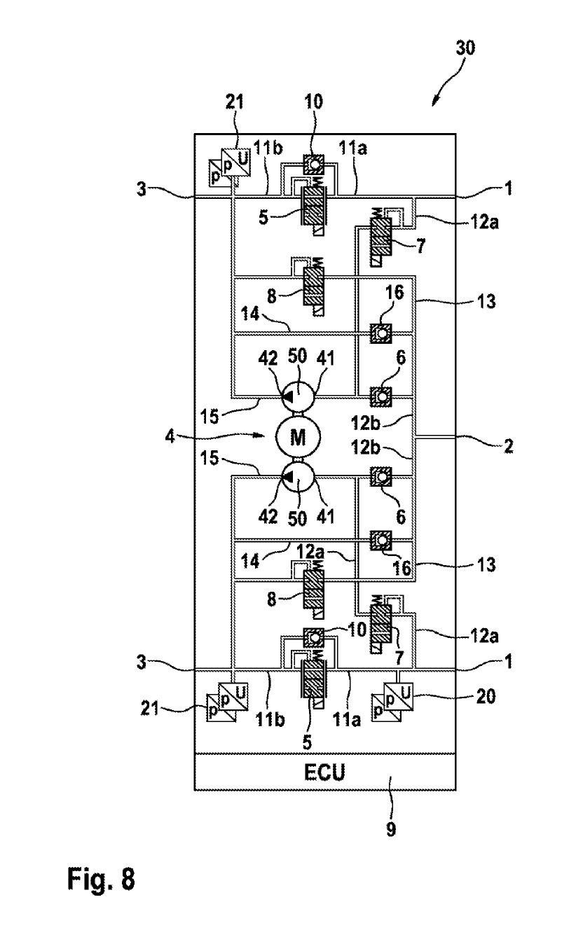

The seventh exemplary embodiment of the arrangement 30, shown in FIG. 8, is based on the fifth exemplary embodiment (FIG. 5). In addition, for each circuit a hydraulic connection 14 is provided from the tank port 2 to the outlet pressure port 3, in which a further (second) check valve 16 is present which opens in the direction of the outlet pressure port 3. Here again, check valves 16 with very low opening pressure and minimal residual leakage are used. For this, in particular check valves with a valve seat sealed with elastomer would be suitable. On the connection 14 shown in FIG. 8 with the check valve 16, it is advantageous that this connection 14 with a suitable check valve 16 allows a volume flow from the tank port 2 to the outlet pressure port 3 with little hydraulic resistance. This advantage is useful for example in an exemplary brake system as shown in FIG. 9.

The arrangement 30 corresponding to the seventh exemplary embodiment shown in FIG. 8 (i.e., with connection 14 with second check valve 16) may also be configured as a four-circuit arrangement with four inlet pressure ports 1, four outlet pressure ports 3 and four pumps 50 (similar to the exemplary embodiment of FIG. 4). An arrangement corresponding to the seventh exemplary embodiment is also possible with two tank ports 2, similar to FIG. 3. An arrangement corresponding to the seventh exemplary embodiment is also advantageous without the valves 7 and 8, similar to FIG. 1.

FIG. 7 shows diagrammatically a first exemplary embodiment of a brake system according to the invention. The brake system is a simulator brake system with essentially: a brake master cylinder 100 which can be actuated directly by a brake pedal via a pushrod; a pressure medium storage tank 140 assigned to the brake master cylinder 100 and under atmospheric pressure; a (travel) simulation device 180 cooperating with the brake master cylinder 100; an electrically controllable pressurization device 190; an electrically controllable pressure modulation device 154 for setting brake pressures at individual wheels for the wheel brakes 151a-151d; a first electronic control and regulator unit 146 configured to actuate the pressurization device 190 and the pressure modulation device 150; and an electrically controllable pump-valve arrangement 130 as an additional module to which a second electronic control and regulator unit 9 is assigned.

The pressure modulation device 150 comprises inlet valves 152a-152d and outlet valves 153a-153d for individual wheels. The inlet ports of the inlet valves 152a-152d are supplied via brake circuit supply lines I, II with pressures which, in a first operating mode (e.g., “brake-by-wire”), are derived from a system pressure which is present in a system pressure line 191 connected to the pressurization device 190. The hydraulic connection between the system pressure line 191 and the brake circuit supply line I, II may be interrupted by means of an advantageously normally closed switching valve 182a, 182b for each brake circuit. In a second operating mode, the brake circuit supply lines I, II are connected to the assigned brake master cylinder pressure chamber 133, 134 via an advantageously normally open isolating valve 181a, 181b for each brake circuit. The outlet ports of the outlet valves 153a-153d are connected to the pressure medium storage tank 140 via a common return line 154.

According to the example, the wheel brakes 151a and 151b are assigned to the front left wheel FL and rear right wheel RR and the brake circuit supply line I, and wheel brakes 151c and 161d are assigned to the front right wheel FR and rear left wheel RL and brake circuit supply line II. Other brake circuit divisions are conceivable.

The dual-circuit brake master cylinder 100 comprises two pistons 131, 132 arranged behind each other and delimiting two hydraulic pressure chambers 133, 134. The first piston 131 is mechanically coupled to the brake pedal and is actuated directly by the vehicle driver, without the interposition of a brake servo. Pressure-balancing lines 135a, 135b to the pressure medium storage tank 140 are assigned to the pressure chambers 133, 134. A normally open (NO) diagnostic valve 184 is contained in the pressure-balancing line 135a.

To detect an actuation of the brake master cylinder 100, a travel sensor 138—advantageously configured redundantly—is provided which detects, e.g., a movement of the piston 131 and/or 132.

A pressure sensor 186 detects the pressure which has built up in the pressure chamber 134 by the movement of the second piston 132.

The simulation device 180 may be coupled hydraulically to the brake master cylinder 100 and essentially comprises a simulator chamber 188, a simulator spring chamber 189, and a simulator piston 192 separating the two chambers from each other. The simulator piston 192 rests on the housing via an elastic element (e.g., spring) which is arranged in the simulator spring chamber 188 and is advantageously pretensioned. The simulator chamber 188 may be connected by means of an electrically actuatable simulator release valve 193 to the pressure chamber 133 of the brake master cylinder 100. When a pedal force is applied and the simulator release valve 193 activated, pressure medium flows from the brake master cylinder pressure chamber 133 into the simulator chamber 188. A check valve 194 arranged hydraulically in antiparallel to the simulator release valve 193 allows a largely unhindered back-flow of pressure medium, independently of the switch state of the simulator release valve 193, from the simulator chamber 188 to the brake master cylinder pressure chamber 133.

The electrically controllable pressurization device 190 is configured as a hydraulic cylinder-piston arrangement or as a single-circuit electrohydraulic actuator, the piston 195 of which can be actuated by an electric motor 196 (depicted diagrammatically) with the interposition of a rotation-translation gear mechanism, also depicted diagrammatically. A rotor position sensor (depicted merely diagrammatically), which serves to detect the rotor position of the electric motor 196, is designated with the reference numeral 197. In addition, a temperature sensor 198 may be used to detect the temperature of the motor winding. The piston 195 delimits a pressure chamber 199 which is connected to the system pressure line 191. Pressure medium can be drawn into the pressure chamber 199 by retraction of the piston 195 when the switching valves 182a, 182b are closed, in that pressure medium can flow from the tank 140 into the actuator pressure chamber 199 via an intake line 135c with a check valve which opens in the flow direction towards the actuator 190 and is not designated individually. To detect the pressure prevailing in the system pressure line 191, a pressure sensor 187 is provided which is preferably configured redundantly.

The exemplary pump-valve arrangement 130 is configured with four circuits, i.e., the arrangement comprises four inlet pressure ports 1, each with an assigned outlet pressure port 3 and pump 50. The pump-valve arrangement 130 is connected hydraulically downstream of the inlet valves 152a-152d, i.e., for each wheel brake circuit, it is arranged between the inlet valve 152 and the assigned wheel brake 151. The pump-valve arrangement 130 only has a single tank port 2.

For each (wheel) circuit, the pump-valve arrangement 130 has a (first) valve 5 with parallel check valve 10, a (second) valve 7 and an outlet valve 8 corresponding to the sixth exemplary embodiment of FIG. 6. All outlet valves 8 are here connected to the tank port 2 via a common hydraulic connection 34. For each pair of wheel brakes 151a, 151b or 151c, 151d, the suction sides 41 of the associated pumps 50 are connected together via a line portion 12b and connected jointly to the tank port 2 via a (first) check valve 6 (similar to the sixth exemplary embodiment of FIG. 6).

The hydraulic components of the brake system according to the example are arranged in two hydraulic units (modules), wherein the pump-valve arrangement 130 forms one of the modules. An electronic control and regulator unit 146, 9 is assigned to each hydraulic unit.

Preferably, each of the electronic control and regulator units 146, 9 is supplied by its own electric power supply 201, 202.

FIG. 9 shows diagrammatically a second exemplary embodiment of a brake system. The brake system substantially includes: a brake actuator 210 with brake master cylinder 100 and brake servo 300 connected upstream thereof; an exemplary, electrically controllable pump-valve arrangement 230, to which a second electronic control and regulator unit 9 is assigned; and a conventional ESC module 220 (electrically controllable pressurization device), to which a first electronic control and regulator unit 146 is assigned. Here, the exemplary arrangement 230 is arranged between the brake actuator 210 and the ESC module 220, i.e., the arrangement is arranged upstream of the inlet valves 152a-152d.

The brake actuator includes, for example, a brake master cylinder 100, which can be actuated by the brake pedal and has pressure chambers 133 and 134, wherein two wheel brakes 151a, 151b or 151c, 151d are assigned to each pressure chamber, and a pressure medium storage tank 140 assigned to the brake master cylinder and standing under atmospheric pressure.

The ESC module 220 comprises a dual-circuit motor-pump assembly 292 with a low-pressure accumulator 291 and two electrically controllable valves 293, 294 per circuit, and an electrically controllable pressure modulation device 150 with an inlet valve 152a-152d and an outlet valve 153a-153d for each wheel brake, for setting brake pressures at individual wheels for the wheel brakes 151a-151d.

The pump-valve arrangement 230 configured with two circuits corresponds to the arrangement of the seventh exemplary embodiment of FIG. 8.

Since the pump-valve module 230 is arranged between the brake actuator 210 and the conventional ESC module 220, the pump of the ESC module must—for example for ESC or TCS brake control interventions—draw in pressure medium volume via the actuator 210 or 100 from the tank 140. Here, as low a hydraulic resistance as possible is advantageous, since the lower the hydraulic resistance for the pump on suction, the faster it can deliver pressure medium and hence build up brake pressure.

When the ESC pump sucks either via the actuator and also via the NO analog valve 5 of the pump-valve module 230, or via the pump and the upstream check valve of the pump-valve arrangement, in some cases the hydraulic resistances may be too high, which can lead to a choke effect for the ESC pump pressure build-up volume flow. On ESC brake control intervention for example, this could lead to problems if the pressure cannot be built up quickly enough. Therefore a connection 14 is advantageous which contains only a suitable check valve 16 and hence has a low hydraulic resistance, and connects the tank port 2 directly to the pressure output 3.

In electrically servo-assisted brake systems, an adequate level of availability must be ensured. A high availability is preferably achieved in that the brake system is supplied from at least two mutually independent electrical power sources 201, 202. Furthermore, preferably the components at risk of possible failure such as ECUs (electronic control and regulator unit) and actuators (in particular, electrically controllable pressure source) are configured redundantly.

Preferably, a main brake system known in itself builds up the system pressure in normal brake mode, and an arrangement (pump-valve module) according to the invention is provided for the case where the system pressurization function of the main brake system has failed. In this situation, the pump-valve module takes over the pressure build-up function. The pump-valve module may both amplify a driver's braking request hydraulically, and build up pressure independently of the driver.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. An arrangement for a hydraulic motor vehicle brake system, with an inlet pressure port for connection to a pressure source, a tank port for connecting to a pressure medium tank, and an outlet pressure port, said arrangement comprising:
a hydraulic connection between the inlet pressure port and the outlet pressure port, in which a normally open first valve is arranged which can be actuated in analog fashion; and
a pump arrangement with at least one pump, with a suction side connectable to the inlet pressure port, and a pressure side connectable to the outlet pressure port;
wherein the suction side is connected to the tank port, and
wherein a first check valve opening in the direction of the suction side is disposed between the suction side and the tank port.

2. The arrangement as claimed in claim 1, wherein a volume output side of the first check valve is connected to the hydraulic connection between the suction side and the inlet pressure port.

3. The arrangement as claimed in claim 1, wherein no valve is arranged in the hydraulic connection between the suction side and the inlet pressure port.

4. The arrangement as claimed in claim 1, wherein a single normally closed second valve is arranged in the hydraulic connection between the suction side and the inlet pressure port.

5. The arrangement as claimed in claim 1, further comprising a hydraulic connection provided between the outlet pressure port and the tank port, in which a normally closed third valve is arranged.

6. The arrangement as claimed in claim 1, further comprising a hydraulic connection provided between the outlet pressure port and the tank port, in which a second check valve is arranged which opens in the direction of the outlet pressure port.

7. The arrangement as claimed in claim 1, further comprising multiple circuits wherein each circuit includes an inlet pressure port, an outlet pressure port, a pump with suction side connectable to the inlet pressure port and with a pressure side connectable to the outlet pressure port, and a normally open first valve which can be controlled in analog fashion and is arranged between the inlet pressure port and the outlet pressure port.

8. The arrangement as claimed in claim 7, further comprising only one tank port, wherein the suction sides of the pumps are connected to the tank port.

9. The arrangement as claimed in claim 8, wherein for each circuit, a first check valve is arranged between the suction side of the pump and the tank port.

10. The arrangement as claimed in claim 8, wherein two or more suction sides are jointly connected to the tank port via a first check valve.

11. The arrangement as claimed in claim 7, wherein for each circuit, a tank port and a first check valve are arranged between the suction side of the pump and the tank port.

12. The arrangement as claimed in claim 7, further comprising a first pressure detection device which detects the pressure at one of the inlet pressure ports and a second pressure detection device which detects the pressure at one of the outlet pressure ports.

13. The arrangement as claimed in claim 1, further comprising an electronic control and regulator unit.

14. A brake system for a motor vehicle for actuation of hydraulically actuatable wheel brakes, comprising:
a brake master cylinder which can be actuated via a brake pedal and includes a plurality of pressure chambers, wherein at least one wheel brake is assigned to each pressure chamber;
a pressure medium storage tank assigned to the brake master cylinder and standing under atmospheric pressure;
an electrically controllable pressure modulation device for setting brake pressures at individual wheels, with at least one inlet valve and in particular one outlet valve for each wheel brake;
an electrically controllable pressurization device; and
an arrangement including:
a hydraulic connection between the inlet pressure port and the outlet pressure port, in which a normally open first valve is arranged which can be actuated in analog fashion; and
a pump arrangement with at least one pump, with a suction side connectable to the inlet pressure port, and a pressure side connectable to the outlet pressure port;
wherein the suction side is connected to the tank port, and
wherein a first check valve opening in the direction of the suction side is disposed between the suction side and the tank port.

15. The brake system as claimed in claim 14, wherein each inlet pressure port of the arrangement is connected, in particular without the interposition of a valve, to the brake master cylinder, and that each outlet pressure port of the arrangement is connected to the pressurization device, wherein in particular the pressurization device comprises a pump and valves, and in particular a low-pressure accumulator.

16. The brake system as claimed in claim 14, wherein each inlet pressure port of the arrangement is connected, in particular without the interposition of a valve, to the pressure modulation device, and that each outlet pressure port of the arrangement is connected, in particular without the interposition of a valve, to one of the wheel brakes.

17. The brake system as claimed in claim 14, further comprising a first electronic control and regulator unit which is assigned to the pressurization device and the pressure modulation device, and a second electronic control and regulator unit which is assigned to the arrangement.
